(19) United States
(12) Patent Application Publication
(10) Pub. No.: US 2007/0065063 A1
(43) Pub. Date: Mar. 22, 2007

(54) Rotary device having laterally movable axle

(76) Inventor: Hsien Mo Lin, Taichung (TW)

Correspondence Address: CHARLES E. BAXLEY, ESQ., 90 JOHN STREET, THIRD FLOOR, NEW YORK, NY, 10038, US

(21) Appl. No.: 11/113,854

(22) Filed: Apr. 25, 2005

(51) Int. Cl. F16C 43/00

(52) U.S. Cl. 384/537

(57) ABSTRACT

A rotary device includes an axle, a rotary member, a barrel slidably engaged onto the axle and disposed in the rotary member, and one or more bearings engaged between the rotary member and the barrel, to allow the bearing and the rotary member and the barrel to slide relative to the axle. The barrel includes a peripheral flange or rib for stably attaching the bearings to the barrel. The axle includes an end cap secured to a reduced end segment, for engaging with the barrel and the bearing, and for preventing the barrel and the bearing from being disengaged from the axle. The bearings each includes an inner race and an outer race, and two gaskets disposed and engaged with the inner and the outer races of the bearings.

### BACKGROUND OF THE INVENTION

1. Field of the Invention

The present invention relates to a rotary device, such as a pulley, a roller, a wheel or the like, and more particularly to a rotary device having a laterally movable axle for allowing the rotary device to be laterally movable relative to a longitudinal supporting track or rail.

2. Description of the Prior Art

Typical pulleys, rollers, wheels or the other rotary devices comprise a rotary member rotatably attached or secured onto a shaft or an axle with one or more bearings, to allow the rotary member to be rotated relative to the shaft or axle. The axle may be attached or secured onto an object, a carrier or the like, and the rotary member may be rotatably attached or engaged onto a longitudinal track or rail, to allow the object or the carrier to smoothly move along the longitudinal track or rail.

For example, U.S. Pat. No. 3,770,992 to Veglia, and U.S. Pat. No. 4,960,334 to Mazziotti disclose two of the rotary devices each also comprising a rotary member or an object or a carrier or the like rotatably attached or engaged or secured onto a shaft or an axle with a bearing, to allow the rotary member or the object or the carrier to be rotated relative to the shaft or axle, and to allow the carrier or other objects to smoothly move along the longitudinal track or rail.

The bearing is solidly or fixedly secured between the rotary member or the object or the carrier and the shaft or axle, such that the rotary member or the object or the carrier may not be moved laterally relative to the shaft or axle.

However, for example, when two or more rotary members are attached onto the object or the carrier and are rotatably attached or secured onto a shaft or an axle with one or more bearings, and are rotatably attached or engaged onto two or more longitudinal tracks or rails, and when the longitudinal tracks or rails are not parallel to each other and may have some portions closer to each other and the other portions spaced further away from each other, the rotary members and the bearings may not be moved laterally relative to the supporting tracks or rails, such that the rotary members and the bearings and thus the object or the carrier may have a good chance to be separated or disengaged from or fall off the longitudinal tracks or rails.

The present invention has arisen to mitigate and/or obviate the afore-described disadvantages of the conventional rotary devices for rotatably or slidably supporting the carriers on longitudinal tracks or rails.

### SUMMARY OF THE INVENTION

The primary objective of the present invention is to provide a rotary device including a laterally movable axle for allowing the rotary device to be laterally movable relative to a supporting track or rail.

In accordance with one aspect of the invention, there is provided a rotary device comprising an axle, a rotary member, a barrel slidably engaged onto the axle, and disposed in the rotary member, and at least one bearing engaged between the rotary member and the barrel, to allow the bearing and the rotary member and the barrel to slide relative to the axle.

The barrel includes a peripheral flange radially extended outwardly therefrom, for engaging with the bearing, and for stably attaching the bearing to the barrel, and/or the barrel may further include a peripheral rib radially extended outwardly therefrom, for engaging with the bearing, and for firmly securing the bearing to the barrel.

The rotary member includes a bore formed therein, and a peripheral flange radially extended into the bore thereof, to form a peripheral shoulder therein, and to engage with the bearing. The rotary member includes a peripheral depression formed therein, for engaging with a clamping ring which may engage with the bearing, to stably secure the bearing to the rotary member. The rotary member includes an inner peripheral member disposed therein and having a rigidity greater than that of the rotary member, for engaging with the bearing.

The axle includes a radially enlarged swelling provided in an intermediate portion thereof, to form a reduced end segment, the barrel is slidably engaged onto the reduced end segment of the axle. The axle includes an end cap secured to the reduced end segment with such as a fastener, for engaging with the barrel and the bearing, and for preventing the barrel and the bearing from being disengaged from the axle.

The axle includes a gasket engaged on to the reduced end segment, for engaging with the barrel and the bearing, and for preventing the barrel and the bearing from being directly engaged onto the end cap.

The rotary member includes a second bearing engaged between the rotary member and the barrel. The two bearings each includes an inner race and an outer race, and two gaskets disposed and engaged with the inner races and the outer races of the bearing and the second bearing. Two or more barrels and two or more rotary members may be slidably attached onto the axle, and movable toward or away from each other, to allow the barrels and the rotary members to be smoothly engaged onto two or more longitudinal tracks or rails that are not parallel to each other, or that include some portions closer to each other and the other portions spaced further away from each other.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view illustrating an attachment of a rotary device in accordance with the present invention onto a pair of tracks or rails;

FIG. 2 is a partial exploded view of the rotary device having a laterally movable axle;

FIG. 3 is a partial perspective view of the rotary device having the laterally movable axle;

FIG. 4 is an enlarged partial cross sectional view of the rotary device, illustrating the operation of the rotary device; and

FIGS. 5, 6, 7 and 8 are enlarged partial cross sectional views similar to FIG. 4, illustrating the other arrangements of the rotary device.

### DETAILED DESCRIPTION OF THE PREFERRED EMBODIMENT

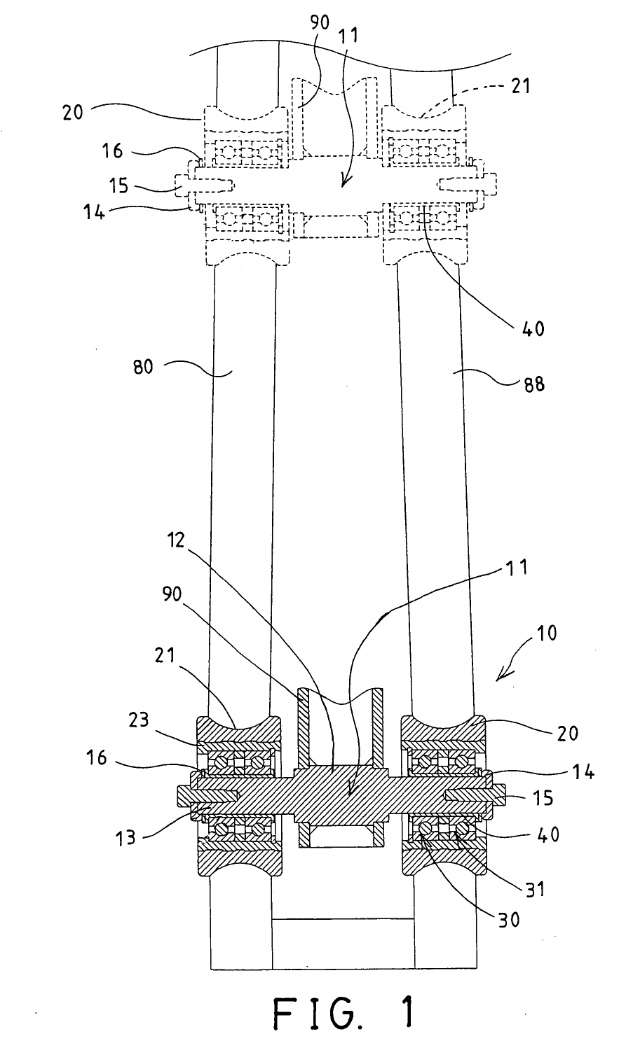

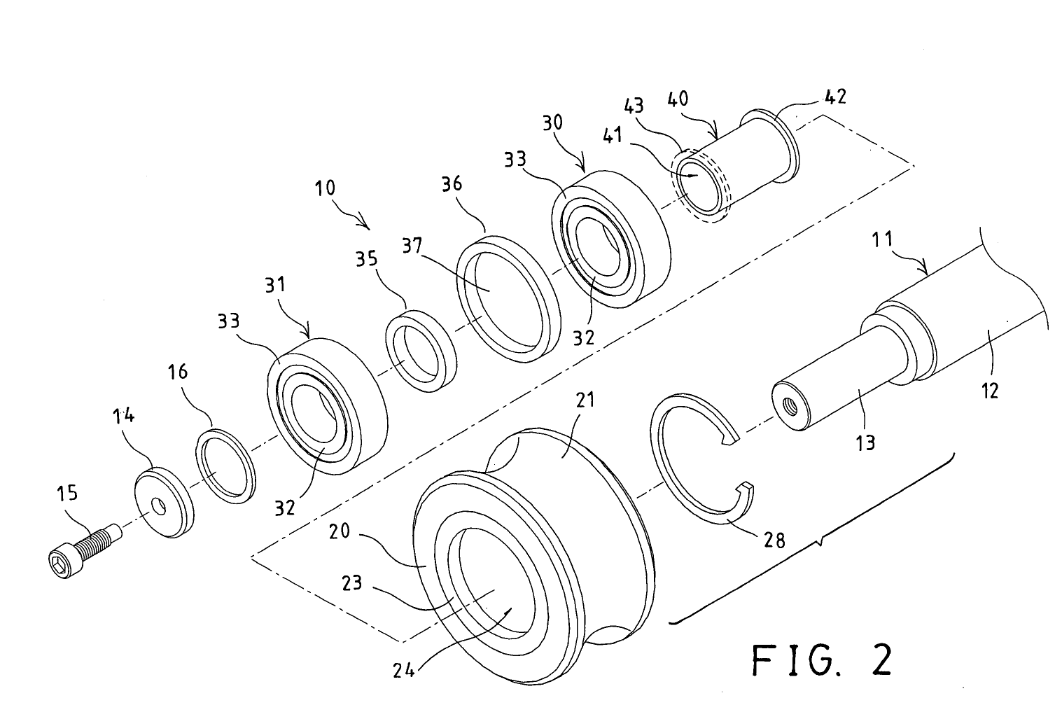

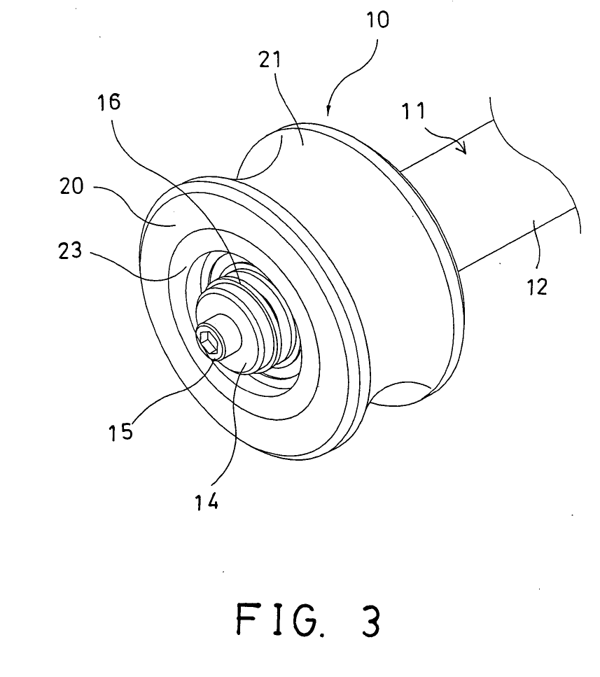

Referring to the drawings, and initially to FIGS. 1-4, a rotary device 10 in accordance with the present invention comprises a shaft or axle 11, and one or more, such as two pulleys, rollers, wheels or rotary members 20 or the like each rotatably attached onto the axle 11 with one or more bearings 30, 31, and each rotatably and slidably engaged onto a longitudinal track or rail 80, 88, and arranged to allow the rotary members 20 to be laterally movable relative to the axle 11 (FIG. 1), particularly when the longitudinal tracks or rails are not parallel to each other and have some portions closer to each other and the other portions spaced further away from each other.

The axle 11 may include a radially enlarged bulge or swelling 12 formed or provided in a middle or intermediate portion thereof, best shown in FIGS. 1 and 4-8, to form or define one or more, such as two reduced end portions or end segments 13. A stop or an end cap 14 may be secured to the outer end portion of each of the end segments 13 of the axle 11 with such as a fastener 15, and may include an outer diameter greater than that of the end segments 13 of the axle 11. A washer or a gasket 16 may further be provided and slidably attached onto each of the end segments 13 of the axle 11, and contactable with the end cap 14.

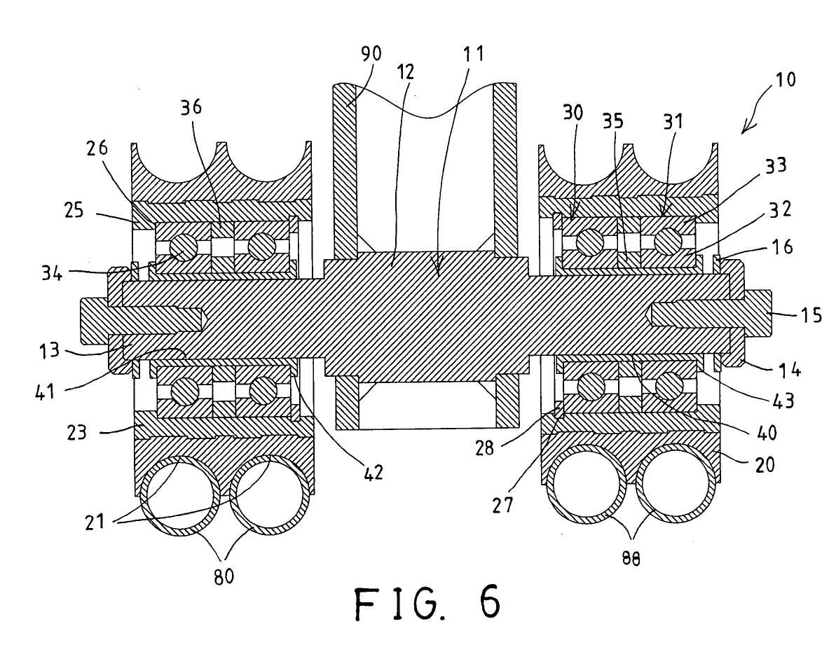

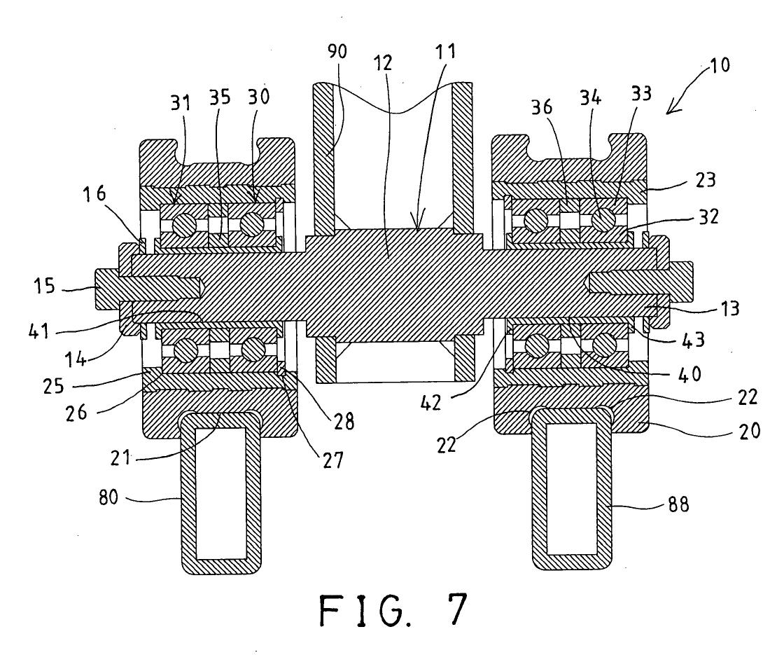

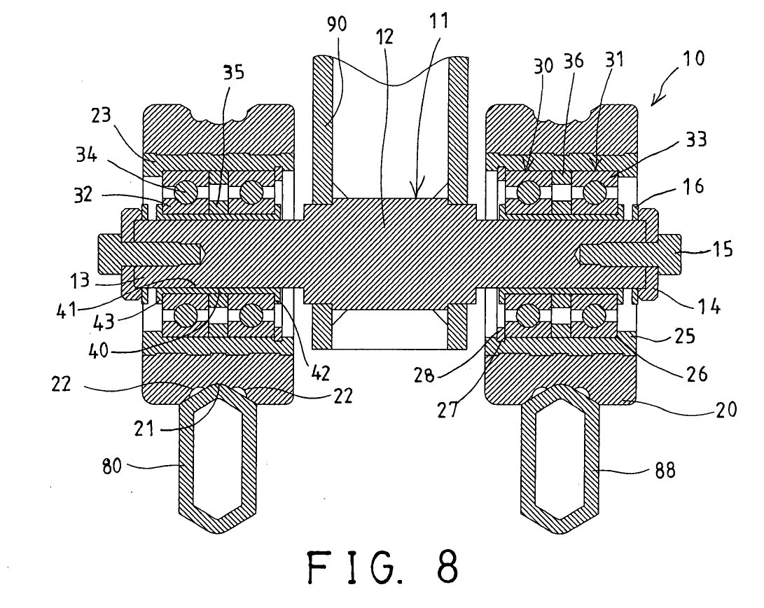

Each of the rotary members 20 includes an outer peripheral recess 21 formed therein, for smoothly engaging with the longitudinal track or rail 80, 88 (FIGS. 1 and 4-8), and for allowing the rotary members 20 to be smoothly moved along the longitudinal tracks or rails 80, 88. The outer peripheral recesses 21 of the rotary members 20 may include various kinds of cross sections, such as one (FIGS. 1, 4, 5) or more (FIG. 6) curved or concaved cross sections, or rectangular-shaped cross section (FIG. 7), or angle-shaped cross section (FIG. 8), or the like, for smoothly engaging with the longitudinal tracks or rails 80, 88 having corresponding cross sections.

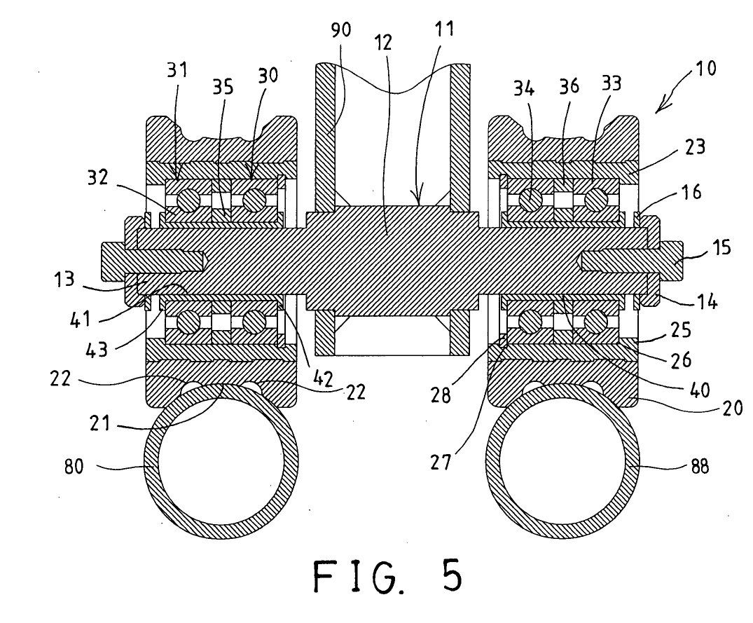

As shown in FIGS. 5 and 7-8, each of the rotary members 20 may further include one or more peripheral grooves 22 formed in the outer peripheral portion thereof, and communicating with the outer peripheral recess 21 thereof, for increasing the resilience and/or the deformability of the rotary members 20, and thus for allowing the rotary members 20 to be snugly and smoothly engaged with and moved along the longitudinal tracks or rails 80, 88. Each of the rotary members 20 may further include an inner peripheral member 23 formed or provided therein and preferably having a rigidity or hardness or stiffness greater than that of the rotary members 20.

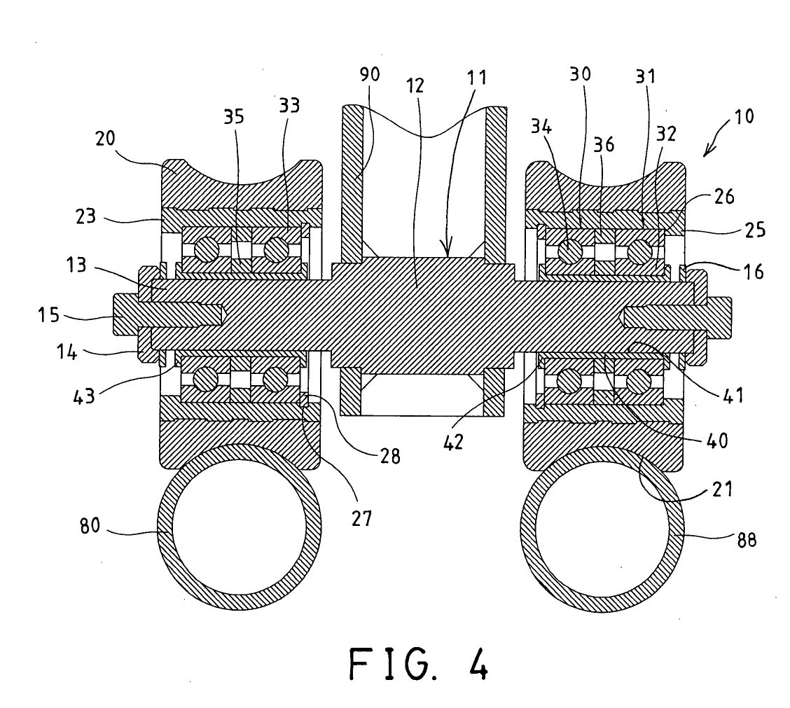

Each of the rotary members 20 further includes a bore 24 formed therein, and a peripheral flange 25 radially extended into the bore 24 thereof, from such as the outer portion thereof, to form or define a peripheral shoulder 26 therein, and for engaging with the outer portion of the bearings 30, 31, best shown in FIGS. 4-8, and may further include a peripheral depression 27 formed therein, such as formed in the inner portion thereof, for receiving or engaging with a clamping ring 28 which may be engaged with the inner portion of the bearings 30, 31, for example, in order to stably or firmly attach or secure or anchor the bearings 30, 31 in the rotary members 20.

A barrel 40 is disposed in each of the rotary members 20 and includes a bore 41 formed therein to slidably receive and to slidably engage onto the end segments 13 of the axle 11 respectively, and includes a peripheral flange 42 radially extended outwardly therefrom, such as from the inner portion thereof, for engaging with the inner portion of the bearings 30, 31, and another peripheral rib 43 radially extended outwardly therefrom, such as from the outer portion thereof, for engaging with the outer portion of the bearings 30, 31, in order to stably or firmly attach or secure or anchor the bearings 30, 31 to the barrel 40. The barrel 40 is movable between the enlarged intermediate swelling 12 and the end cap 14 or the gasket 16 of the axle 11. The peripheral rib 43 may be forged or riveted onto the barrel 40 after the bearings 30, 31 have been engaged or secured onto the barrel 40, for example.

The bearings 30, 31 each includes an inner race 32 engaged or secured onto the barrel 40, and engaged with the peripheral flange 42 and the peripheral rib 43, to stably or firmly attach or secure or anchor the bearings 30, 31 to the barrel 40, and each includes an outer race 33 engaged or secured onto the rotary members 20, and engaged with the peripheral flange 25 and the clamping ring 28 of the rotary members 20, to stably or firmly attach or secure or anchor the bearings 30, 31 to the rotary members 20, and each includes a number of rollers or balls 34 engaged between the inner race 32 and the outer race 33, to allow the rotary members 20 to smoothly rotate relative to the barrel 40 and the axle 11.

It is preferable that one or more, such as two washers or gaskets 35, 36 may further be provided and disposed or engaged onto the barrel 40 and disposed between the inner races 32 and the outer races 33 of the bearings 30, 31 respectively, and arranged to have the inner or smaller gasket 35 disposed or engaged within a bore 37 of the outer or greater gasket 36, to allow the inner races 32 and the outer races 33 of the bearings 30, 31 to be spaced away from each other and engaged with each other with the smaller and the greater gaskets 35, 36 respectively.

In operation, as shown in FIGS. 1 and 4, the axle 11 may be attached or secured to an object or a carrier 90 or the like, and the rotary members 20 may be rotatably and slidably engaged onto the longitudinal tracks or rails 80, 88 respectively, to allow the object or the carrier 90 to smoothly slide or move along the longitudinal tracks or rails 80, 88 respectively. The barrel 40 and the bearings 30, 31 and thus the rotary members 20 and the carrier 90 are laterally movable relative to the axle 11 and movable between the enlarged intermediate swelling 12 and the end cap 14 or the gasket 16 of the axle 11.

As shown in FIG. 1, when the longitudinal tracks or rails 80, 88 are not parallel to each other and when the longitudinal tracks or rails 80, 88 have some portions closer to each other and the other portions spaced further away from each other, the rotary members 20 and the bearings 30, 31 and the barrel 40 are laterally movable relative to the axle 11, to allow the rotary members 20 to be moved toward each other or away from each other, and thus to allow the rotary members 20 to be smoothly moved along the longitudinal tracks or rails 80, 88 respectively. The gasket 16 may thus be used to engage with the barrel 40 and/or the bearings 30, 31, and to prevent the barrel 40 and/or the bearings 30, 31 from being directly engaged onto the end cap 14 of the axle 11, and to prevent the barrel 40 and/or the bearings 30, 31 from being disengaged from the axle 11.

Accordingly, the rotary device in accordance with the present invention includes a laterally movable axle for allowing the rotary device and thus the carrier to be laterally movable relative to a supporting track or rail.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A rotary device comprising:
an axle,
a rotary member,
a barrel slidably engaged onto said axle, and disposed in said rotary member, and
at least one bearing engaged between said rotary member and said barrel, to allow said at least one bearing and said rotary member and said barrel to slide relative to said axle.

2. The rotary device as claimed in claim 1, wherein said barrel includes a peripheral flange radially extended outwardly therefrom, for engaging with said at least one bearing, and for stably attaching said at least one bearing to said barrel.

3. The rotary device as claimed in claim 1, wherein said barrel includes a peripheral rib radially extended outwardly therefrom, for engaging with said at least one bearing, and for firmly securing said at least one bearing to said barrel.

4. The rotary device as claimed in claim 1, wherein said rotary member includes a bore formed therein, and a peripheral flange radially extended into said bore thereof, to form a peripheral shoulder therein, and to engage with said at least one bearing.

5. The rotary device as claimed in claim 1, wherein said rotary member includes a peripheral depression formed therein, for engaging with a clamping ring which may engage with said at least one bearing, to stably secure said at least one bearing to said rotary member.

6. The rotary device as claimed in claim 1, wherein said rotary member includes an inner peripheral member disposed therein and having a rigidity greater than that of said rotary member, for engaging with said at least one bearing.

7. The rotary device as claimed in claim 1, wherein said axle includes a radially enlarged swelling provided in an intermediate portion thereof, to form a reduced end segment, said barrel is slidably engaged onto said reduced end segment of said axle.

8. The rotary device as claimed in claim 7, wherein said axle includes an end cap secured to said reduced end segment, for engaging with said barrel and said at least one bearing, and for preventing said barrel and said at least one bearing from being disengaged from said axle.

9. The rotary device as claimed in claim 8, wherein said axle includes a gasket engaged on to said reduced end segment, for engaging with said barrel and said at least one bearing, and for preventing said barrel and said at least one bearing from being directly engaged onto said end cap.

10. The rotary device as claimed in claim 1, wherein said rotary member includes a second bearing engaged between said rotary member and said barrel.

11. The rotary device as claimed in claim 10, wherein said at least one bearing and said second bearing each includes an inner race and an outer race, and two gaskets disposed and engaged with said inner races and said outer races of said at least one bearing and said second bearing.
